(19) United States
(12) Patent Application Publication
(10) Pub. No.: US 2025/0004913 A1
(43) Pub. Date: Jan. 2, 2025

(54) DYNAMIC RUNTIME COMPUTER CODE MONITORING

(71) Applicant: Oligo Cyber Security LTD., Tel Aviv (IL)

(72) Inventors: Nadav Czerninski, Tel Aviv (IL); Gal Elbaz, Tel Aviv (IL); Avshalom Elchanan Hilu, Mevasseret Zion (IL)

(21) Appl. No.: 18/755,303

(22) Filed: Jun. 26, 2024

Related U.S. Application Data
(60) Provisional application No. 63/525,438, filed on Jul. 7, 2023.
(60) Provisional application No. 63/524,344, filed on Jun. 30, 2023.

(51) Int. Cl. G06F 11/36

(52) U.S. Cl. CPC G06F 11/3612

(57) ABSTRACT

A computer implemented method of dynamic runtime computer code monitoring, the method comprising steps that a computer processor is programmed to perform, the steps comprising: during execution of a computer code, detecting a plurality of system calls initiated during the execution, during the execution of the computer code, selecting a least one of the detected system calls, based on a selection criterion, and analyzing the selected system call, according to at least one predefined rule.

### CROSS-REFERENCE TO RELATED APPLICATIONS

The present application claims priority from U.S. Provisional Patent No. 63/524,344 filed on Jun. 30, 2023 and U.S. Provisional Patent No. 63/525,438 filed on Jul. 7, 2023, the contents of which are hereby incorporated by reference in their entirety without giving rise to disavowment.

### TECHNICAL FIELD AND BACKGROUND

The disclosed subject matter relates to computer code execution monitoring and, more particularly, but not exclusively to a system and method of dynamic runtime monitoring of computer code execution.

With the development of computer science and software engineering, complex software systems have assumed an increasingly important role in our lives. However, in recent years, the need to ensure the safety and reliability of such software systems (say against cybersecurity threats) has become an increasingly challenging task.

In many cases, software quality assurance and data security technologies that consist of software testing, reliability testing, formal verification, reliability prediction and estimation, and standard compliance, have failed to ensure software reliability and safety, especially when using interpreter-based computer programming languages and/or after system deployment.

### BRIEF SUMMARY

According to one aspect of the disclosed subject matter, there is provided a computer implemented method of dynamic runtime computer code monitoring, the method comprising steps that a computer processor is programmed to perform, the steps comprising: during execution of a computer code, detecting a plurality of system calls initiated during the execution, during the execution of the computer code, selecting a least one of the detected system calls, based on a predefined criterion, and analyzing the selected system call, according to at least one predefined rule.

According to a second aspect of the disclosed subject matter, there is provided a non-transitory computer readable medium storing computer processor executable instructions for dynamic runtime computer code monitoring, the method comprising steps a computer processor is programmed to perform, the steps comprising: during execution of a computer code, detecting a plurality of system calls initiated during the execution, during the execution of the computer code, selecting a least one of the detected system calls, based on a predefined criterion, and analyzing the selected system call, according to at least one predefined rule.

According to a third aspect of the disclosed subject matter, there is provided a system for dynamic runtime computer code monitoring, the system comprising a circuit comprising a computer processor and a computer memory storing instructions that are executable by the computer processor, for performing the steps of: during execution of a computer code, detecting a plurality of system calls initiated during the execution, during the execution of the computer code, selecting a least one of the detected system calls, based on a predefined criterion, and analyzing the selected system call, according to at least one predefined rule.

Optionally, the selected system calls are fewer than the detected system calls. Optionally, the selection criterion is based at least on system call type.

Optionally, according to the selection criterion, all system calls of a first type are selected and subjected to said analyzing, but only some of a plurality of system calls of a second type are selected and subjected to said analyzing.

Optionally, said selecting is carried out during the execution of the computer code, by determining for each respective one of the detected system calls, before execution of an operating system service responsive to the respective system call, whether the respective system call should be analyzed.

Optionally, the predefined criterion is based at least partially on a sampling rate predefined for each respective one of a plurality of system call types.

Optionally, the selection criterion is based at least partially on a sampling rate predefined for each respective one of a plurality of system call types, and updated dynamically.

Optionally, the selection criterion defines a preliminary sampling rate of the detected system calls.

Optionally, the selection criterion defines a preliminary call-type-specific sampling rate for each respective one of a plurality of system call types.

Optionally, the subject matter further includes updating the call-type-specific sampling rate according to a result of said analyzing.

Optionally, the predefined rule relates to a previously learnt behavioral profile of at least a part of the computer code, and said analyzing comprises checking whether an action carried out using the selected system call deviates from the predefined rule.

Optionally, the part of the computer code is included in a computer application, the computer application is different than the computer code, wherein the previously learnt behavior profile is determined based on executions of the computer application, whereby the behavior profile utilized during execution of the computer code is based on executions of a different computer program.

Optionally, the predefined rule relates to a previously learnt behavioral profile of a library, the library includes a plurality of functions, wherein the previously learnt behavioral profile of the library is based on behavior of the plurality of functions, wherein the part of the computer code is one of the plurality of functions, and said analyzing comprises checking whether an action carried out using the selected system call deviates from the predefined rule.

### BRIEF DESCRIPTION OF THE DRAWINGS

The disclosed subject matter is herein described, by way of example only, with reference to the accompanying drawings. With specific reference now to the drawings in detail, it is stressed that the particulars shown are by way of example and for purposes of illustrative discussion of embodiments of the disclosed subject matter only, and are presented in order to provide what is believed to be the most useful and readily understood description of the principles and conceptual aspects of the disclosed subject matter. The description taken with the drawings making apparent to those skilled in the art how the several forms of the disclosed subject matter may be embodied in practice.

In the drawings:

FIG. 1 is a simplified flowchart illustrating an exemplary method of dynamic runtime computer code monitoring, according to an exemplary embodiment of the disclosed subject matter.

FIG. 2 is a simplified flowchart illustrating an exemplary scenario of dynamic runtime computer code monitoring, according to an exemplary embodiment of the disclosed subject matter.

FIG. 3 is a simplified block diagram schematically illustrating an exemplary non-transitory computer readable medium having stored thereon instructions for causing a processing circuitry to perform a process of dynamic runtime computer code monitoring, according to an exemplary embodiment of the disclosed subject matter.

FIG. 4 is a simplified block diagram schematically illustrating an exemplary system for dynamic runtime computer code monitoring, according to an exemplary embodiment of the disclosed subject matter.

### DETAILED DESCRIPTION

The present embodiments comprise a method and a system for dynamic runtime computer code monitoring.

One technical problem dealt with by the disclosed subject matter is the ability to monitor dynamically executed code against cybersecurity threats. Specifically, one goal of the disclosed subject matter is to enable protection against complicated attack scenarios without suffering from an excessive performance overhead and without adversely affecting the performance of the system.

With the recent emergence of complex software that involves dynamic execution and compilation of many different functions, concurrency and multi-threading, etc., have made the task of efficiently and effectively monitoring runtime execution of computer code, an extremely challenging one.

In many cases, hitherto used software quality assurance and data security technologies have failed to ensure software reliability. This is particularly the case when the software is coded in interpreter-based computer programming languages (e.g., JavaScript, Python, Perl, or the like) or after the software is installed and used.

Many software vendors have turned to runtime software monitoring technology, to solve the aforementioned problems.

However, the recent emergence of complex software systems that involve dynamic execution and compilation of many different functions, concurrency and multi-threading, etc., have made the task of efficiently and effectively monitoring runtime execution of computer code, an extremely challenging one.

One naive solution would be to process each and every system call that is invoked by a computer code being monitored in runtime. However, such a solution may create a substantial performance overhead.

According to an exemplary embodiment of the disclosed subject matter, there is rather used a dynamic computer code monitoring method.

One technical solution provided by the disclosed subject matter is to provide for a selective monitoring of system call invocations during runtime. With the method of the exemplary embodiment, only some of the system calls invoked by the computer code are analyzed.

In one example, the system calls are monitored dynamically according to a sampling rate, such that only a subset of the system calls are analyzed. The sampling rate may be updated dynamically. As an example, the sampling rate may be increased upon determining a higher risk of a potential malicious activity, such as, for example, an identification of a potential first step of a recognized attack vector. Additionally, or alternatively, the sampling rate may be decreased when no malicious activity appears for a specific time period (e.g., 10 minutes, 10 hours, 48 hours, or the like).

In the exemplary method, during the execution of the computer code, there is detected one or more system calls that are initiated during the execution of the computer code.

During the execution of the computer code, there is selected one or more of the detected system calls, based on a criterion predefined by a user or operator.

Optionally, the selection of the system calls is carried out during the execution of the computer code, by determining for each detected system call, upon detecting the system call's invocation, but before execution of an operating system service responsive to the system call, whether the detected system call should be analyzed.

Optionally, the criterion is based at least on system call type, e.g., based at least partially, on a sampling rate predefined for each respective one of a plurality of system call types.

For example, the criterion may define that all system calls of a first type are analyzed, whereas system calls of a second type are sampled according to a respective, call type-specific sampling rate. In the example, the system calls of the second type are sampled by selecting them randomly, such that some (but not all) of the system calls of the second type are selected for analysis.

Optionally, the criterion that is based at least partially on a sampling rate predefined for each respective one of a plurality of system call types, is updated dynamically.

In one example, the criterion may be defined by a user of a system that implements the exemplary method, in advance of detecting the system calls. Initially, the user-defined criterion defines that only 5% of detected systems call of ‘recv’ type are to be selected for analysis, whereas the user-defined criterion defines that 100% of detected system calls of type ‘fork’ are to be analyzed.

In the example, upon detecting a suspicious activity by one of the detected ‘recv’ system calls that are selected and analyzed by the method, the user-defined criterion is updated, so as to define that 90% of the detected system ‘recv’ system calls are selected for analysis. In some cases, the user-defined criterion may be updated with respect to other system call types, for all system call types, or the like.

In some exemplary embodiments, the selected system call is analyzed according to one or more rules. The one or more rules are defined in advance of the analysis, say by a user or programmer of a system that implements the exemplary method.

Optionally, the predefined rule relates to a previously learnt behavioral profile of a part of the computer code (e.g., a function called by the computer code during execution of the code). The analysis of the selected system call includes checking whether an action carried out using the selected system call deviates from the predefined rule. For example, the predefined rule may define in which circumstances, if any, the part of the computer code may invoke specific system calls. As an example, a certain function may never be allowed to invoke a specific type of system call. As another example, the function may be allowed to invoke network-related system calls only in case they are addressed to a specific server. As yet another example, the function may be allowed to invoke a code execution system call to execute predefined known code segments.

Optionally, the selection criterion relates to a previously learnt behavioral profile of a part of the computer code (say of a function called by the computer code during execution of the code). The selection of the at least one of the detected system calls may be based on the predefined criterion, which include checking whether invocation of the detected system call by the function is suspicious.

As an example, a behavioral profile of the computer code part (say a specific function or other part of the computer code, as known in the art) learnt over one or more previous uses of the computer code part, indicates that the computer code part (say function) never requests access to a computer's camera. Accordingly, in the example, the rule defines that the computer code part is not supposed to access a driver of a camera. In the example, when the computer code part is called by the computer code and the computer code part requests such an access using the system call selected and analyzed, the analysis indicates that an action (namely, the request to access the camera) that deviates from the previously learnt behavioral profile, occurs.

The computer code part may be integrated into the monitored program. In some cases, the computer code part may be part of the monitored program itself, and may not be available elsewhere. So, all the information used to learn the behavior may be based on executions of the monitored program. Additionally, or alternatively, the computer code part may be part of a publicly available library, such as an open-source package, an API of proprietary software, or the like. So, the learnt behavior may be an outcome of analysis of executions of other programs that also utilize the same publicly available library. Additionally, or alternatively, in case the code of the library is available, the learnt behavior may be determined based on inspection of the code and analysis without being executed (e.g., static analysis). In some cases, manual review of the code may be utilized to determine the learnt behavior.

Optionally, the previously learnt behavioral profile of the library is based on an aggregation of behavioral profiles of two or more behavioral profile of a functions or other computer code parts. For example, the behavioral profile of the library may indicate that no function stored in the library is supposed to access any system table if the behavior profiles of two or more of the functions stored in the library indicates the same. As another example, the behavior profile of the library may be determined based on the profile of its functions so that the profile of each function within the library is subsumed by the profile of the library. In some exemplary embodiments, for each activity that any of the functions has in their individual profile, the same activity may be included in the profile of the library. Additionally, or alternatively, the library may not include any activity that is not identified for at least one of the functions of the library.

Optionally, the rule rather relates to a previously learnt behavioral profile of a computer application that the computer code is a part of, and the analyzing comprises checking whether an action carried out using the selected system call deviates from the predefined rule.

One technical effect of the disclosed subject matter may be to provide an efficient monitoring system that monitors usage of system resources while suffering from a reduced overhead. The system may be designed to ensure protection against certain attack vectors, without monitoring all system call invocations. In some exemplary embodiments, by differentiating the sampling rate between different types of system calls, the disclosed subject matter is able to reduce the overhead, while ensuring sufficient monitoring and analysis of potentially critical events. As an example, while not all ‘read’ system calls may be monitored and analyzed, all code execution system calls (e.g., ‘execv’, ‘fork’, etc.) may be monitored. This combination reduces the amount of overall monitored system calls, on the one hand, while on the other hand, ensures that no attack that is based on code execution system call will go unnoticed.

The principles and operation of a system and method according to the disclosed subject matter may be better understood with reference to the drawings and accompanying description.

Before explaining at least one embodiment of the disclosed subject matter in detail, it is to be understood that the disclosed subject matter is not limited in its application to the details of construction and the arrangement of the components set forth in the following description or illustrated in the drawings.

The disclosed subject matter is capable of other embodiments or of being practiced or carried out in various ways. Also, it is to be understood that the phraseology and terminology employed herein is for the purpose of description only and should not be regarded as limiting.

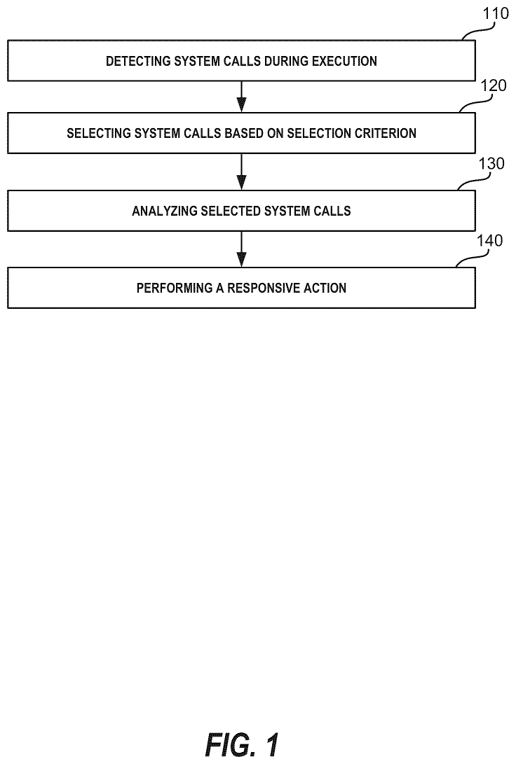

Reference is now made to FIG. 1, which is a simplified flowchart illustrating an exemplary method of dynamic runtime computer code monitoring, according to an exemplary embodiment of the disclosed subject matter.

The exemplary method may be used for implementing a software quality control and/or data security solution on one or more computers, for dynamically monitoring a computer code executed by one or more of the computers, say using system 2000, etc.

Optionally, the computer code is executed in a computing environment that includes an interpreter, or that otherwise involves a use of functions or other computer code parts that are not compiled before the execution of the computer code.

The computer code may include but is not limited to one or more computer programs and/or one or more parts thereof. For example, the computer code may include one or more functions that are called during the execution of a computer application. As another example, the computer code may include one or more libraries, each of which includes functions, some of which may be called during execution of the computer application.

During execution of the computer code, the computer code (e.g., one of the functions called by the computer code) requests one or more services from the operating system of the computer(s) that execute(s) the computer code. The computer code requests the operating system services using one or more system calls. The system calls may include, but are not limited to system calls such as: open, read, write, close, wait, exec, fork, exit, kill, etc., and/or other system calls available on Unix™, Linux™, or other Unix™-like operating systems, systems call available on z/OS™ and z/VSE™ operating systems, etc., as known in the art. It is noted that some system calls may be aggregated into a category due to similar functionality. For example, some system calls relate to network operations and can be classified as a same category. As another example, some system calls relate to code execution and may be classified together. As yet another example, some system calls may relate to accessing files and file storage and may be classified together.

The exemplary method includes steps that at least one computer processor that is a part of a circuit (i.e. hardware and associated circuitry) or of two or more circuits of one or more computers, is/are programmed to perform.

Potentially, with the exemplary method, only some of the system calls invoked by the computer code are analyzed.

Optionally, the system calls are monitored dynamically according to a sampling rate. The sampling rate may be updated dynamically. In some exemplary embodiments, the sampling rate may be updated dynamically, by increasing the sampling rate upon determining a higher risk of a potentially malicious activity of the computer code, by decreasing the sampling rate when no malicious activity is detected for the computer code, or the like.

In the method, there is detected 110, during execution of a computer code, one or more system calls that are invoked during the execution of the computer code, say by the system 2000. Optionally, the system call is detected 110 upon initiation of the system call by the computer code, during the execution of the computer code, but before the service that is responsive to the system call is provided by the operating system of the computer. In one example, the system call is detected 110 using tools for tracing the initiation of system calls in runtime. In some exemplary embodiments, the system call may be detected by reading one or more memory areas in use by the operating system and/or using the Linux™ ‘strace’ utility, or the like. In some exemplary embodiments, eBPF (Berkeley Packet Filter) or other technologies may be utilized to create a hook that is called when a system call is invoked, enabling the detection of the invocation of system calls at kernel mode.

During the execution of the computer code, there is selected 120 one or more of the detected 110 system calls, based on a selection criterion. In some exemplary embodiments, the selection may be performed immediately upon initiation of the system call. Optionally, the selection criterion is pre-configured. Additionally, or alternatively, the selection criterion may be predefined by a user or operator of system 2000.

In some exemplary embodiments, the selection 120 of the system call is carried out during the execution of the computer code, by determining for the detected 110 system call, before execution of an operating system service responsive to the specific system call, whether the specific detected 110 system call should be analyzed 130.

In some exemplary embodiments, the selection 120 criterion is based at least partially, on system call type. In some exemplary embodiments, the criterion may include a sampling rate. The sampling rate may be defined by the user or programmer. In some exemplary embodiments, the sampling rate may be different for different system call types.

In one example, the criterion defines that all system calls of a first type are analyzed 130, whereas system calls of a second type are sampled according to a respective, call type-specific sampling rate, e.g., 10% of the calls, 20% of the calls, or the like.

In the example, the system calls of the second type are sampled by selecting 120 the calls randomly, such that some (but not all) of the system calls of the second type are selected 120 for analysis 130.

Optionally, the criterion that is based, at least partially, on a sampling rate predefined for each respective one of a plurality of system call types, is updated dynamically.

Optionally, the sampling includes randomly selecting 120 some of the detected 110 system calls, such that a portion of a size predefined by a user of computer programmer, is selected 120 for analysis 130. For example, the sampling rate may be 5%, 10%, 15%, 20%, etc.

Thus, in one example, for each detected 110 system call of a certain type, for which type, the selection criterion defines a sampling rate of 10%, there is generated a random number between 0 and 1 (e.g., using a randomizing function). In the example, only if the generated random number is below 0.1, is the detected 110 system call subjected to the step of analyzing 130.

In a second example, a user (e.g., operator or programmer) defines a selection criterion, according to which criterion, initially (e.g., upon the starting of the execution of the computer code), all detected 110 Linux ‘fork’ system calls are selected 120 for analysis 130. The user-defined criterion of the example further defines that only 5% of ‘write’ system calls, but none of the ‘mkdir’ system calls, are analyzed 130.

In the second example, upon detecting a suspicious activity by one of the detected 110 system calls selected 120 and analyzed 130 by the method, the originally user-defined criterion is updated automatically, say so as to define that all detected 110 ‘write” system calls too are selected 120 for analysis 130, and that 20% of the ‘mkdir’ system calls are selected 120 for the analysis 130. As another example, in response to detecting the suspicious activity all system call types are increased to 100% detection rate for a predefined term. The predefined term may be until the end of the execution. Additionally, or alternatively, the predefined term may be limited in duration, such as 10 minutes, 60 minutes, 24 hours, or the like. In some cases, if additional suspicious activities are detected, the time duration may be further extended.

The selected 120 system call is analyzed 130 according to one or more rules. In some exemplary embodiments, the one or more rules are defined in advance of the analyzing, e.g., by a user, a programmer, an operator, or the like, of a system 4000 that implements the exemplary method.

In some exemplary embodiments, the predefined rule used in the analysis 130 relates to a previously learnt behavioral profile of a part of the computer code (e.g., a function used by the computer code), and dictates that the analysis 130 include checking whether an action carried out using the selected 120 system call deviates from the learnt behavioral profile and hence, from the predefined rule.

Thus, in a first example, a behavioral profile of a part of the computer code (e.g., a specific function) learnt over one or more previous uses of the computer code part, indicates that the computer code never requests access to a camera of a computer used to execute the computer code.

Accordingly, in the first example, the rule defines that computer code part is not supposed to access to the resource (camera) of a computer that executes the computer code.

When the computer code requests to access the resource, using the system call selected 120 and analyzed 130, the analysis 130 indicates the occurrence of an action (namely, the attempted access) that deviates from the previously learnt behavioral profile.

As another example, the rules may relate to which system calls may be invoked by the computer code. The rules may relate to specific system calls (e.g., allowed to invoke ‘fork’), categories of system calls (e.g., allowed to invoke system calls relating to execution), or the like. In some exemplary embodiments, the rules may relate to parameters of the system calls. For example, a function may be allowed to invoke network system calls only with respect to certain network resources, e.g., a specific server, servers at a specific namespace, or the like.

In some exemplary embodiments, the rule rather relates to a previously learnt behavioral profile of a library that the computer code part originates from. The profile may represent an aggregation of computer code behavioral profiles learnt over multiple runs of two or more computer code parts (e.g., functions) stored in the library. Hence, based on the aggregation of behaviors of several functions that are included in the same library (or even all functions included in the library), a behavioral profile of the library may be defined and used for some or even all functions in the library.

Accordingly, the analyzing 130 comprises checking whether an action carried out using the selected 120 system call deviates from the predefined rule that is based on the behavioral profile of the library (say the aggregated behavioral profile). Hence, some behaviors that were never observed with respect to a first function but were observed with respect to a second function of the same library, may be considered acceptable and not as deviating from the previously learnt behavior profile. Using an aggregated behavioral profile may reduce amount of false positive indications.

In some exemplary embodiments, the rule rather relates to a previously learnt behavioral profile of a computer application that the computer code forms a part of, and the analyzing 130 comprises checking whether an action carried out using the selected 120 system call deviates from the predefined rule.

Thus, potentially, by ensuring that libraries, functions, applications, and computer code in general, behave in runtime in accordance with their expected and permitted behavior, characteristics of malicious activity not easily detected with hitherto used techniques, may be detected.

Optionally, the system calls are detected 110, selected 120, and/or analyzed 130 using eBPF technologies used to execute sandboxed programs in an operating system kernel. eBPF may potentially provide a safe and efficient manner of extending the capabilities of the kernel without requiring to change kernel source code or load kernel modules.

Thus, in one example, a system call recorder implemented as an eBPF program may be dynamically loaded and invoked each time a system call is invoked and detected 110.

In the example, when the eBPF program is invoked, it may use a randomly generated number, to decide 120 whether to analyze 130 the detected 120 system call or not.

Thus, in one example, the eBPF program generates a random number between zero and one, and if the random number is below the sampling rate (e.g., below 0.15, if the sampling rate is 15%), the system call is analyzed 130.

With the exemplary embodiments, as only some of the detected 110 system calls are subjected to the step of analysis 130, performance overhead related to the monitoring of computer code execution in runtime, is likely to be lower than performance overhead experienced with hitherto used runtime computer code execution monitoring techniques.

In some exemplary embodiments, in the method, in order to determine which library invokes the detected 110 system call, a function recorder program may be used.

Additionally, or alternatively, the function recorder program is a BPF or eBPF program, or rather a program that runs in user-mode.

Additionally, or alternatively, the function recorder programs may be dynamically hooked in one or more position inside the computer code, in which positions, the method and/or function invocations occur.

Additionally, or alternatively, the function recorder program is based on Linux™ uprobes that is a Linux™ kernel technology for providing dynamic tracing of user-level functions. Linux™ uprobes may allow to dynamically instrument user applications, injecting programmable breakpoints at arbitrary instructions. Thus, Linux™ uprobes may allow catching the entry for each method.

With Linux™ uprobes, in a first example, each time a function is called and the function's entry point is reached, the function recorder program may be invoked, and the metadata relating to the invoked method may be logged, potentially together with a timestamp.

The metadata may include, for example, the name of the method, the filename, the class, the arguments passed to the method, etc.

Similarly, Linux™ uretprobes may be used to provide return instrumentation that is invoked on function return events. Thus, in a second example, Linux™ uretprobes may be utilized to catch the return event of every invoked method.

In the second example, each time a return event occurs, the function recorder program may be invoked, and the metadata relating to the method from which the return occurred may be logged, potentially together with a timestamp.

Optionally, the function recorder program is utilized to reconstruct the whole of, or rather a part of, the function stack. For example, in interpreter-based languages, stack reconstruction may be needed as the relevant information may not be easily available through predefined instructions of the programming language or other APIs.

The state of the function stack may help identify which function or library invokes a detected 110 system call. The function/library identification, in turn, may be used in deciding whether to select 120 the system call for the analyzing 140, in the analysis 130 step itself, or in both. In some cases, based on the function/library identification the selection criterion may be retrieved and applied. Additionally, or alternatively, based on the function/library identification the relevant rule may be retrieved and applied.

For example, the selection 120 of a detected 110 system call for analysis 130, may be based on a behavior profile of a specific library that holds a specific part of the computer code (e.g., a function used by the computer code).

Additional details on how such a stack can be reconstructed may be found, for example, in U.S. patent application Ser. No. 18/203,476, titled “DYNAMIC RUNTIME MICRO-SEGMENTATION OF INTERPRETED LANGUAGES”, filed May 30, 2023, which is hereby incorporated by reference in its entirety for all purposes without giving rise to disavowment. However, other techniques may also be utilized, such as the ones disclosed in U.S. Pat. No. 10,481,964, entitled “MONITORING ACTIVITY OF SOFTWARE DEVELOPMENT KITS USING STACK TRACE ANALYSIS”, filed Aug. 20, 2018, which is also hereby incorporated by reference in its entirety for all purposes without giving rise to disavowment.

Thus, potentially, using the selection 120 (e . . . g, random sampling) of system calls for analysis 130 and the reconstructed function stack, it may be possible to detect and monitor all functions, libraries, or other computer code parts even when executed in an interpreter-language based computing environment.

The analysis 130 of the system calls may also be used to generate or to update a behavioral profile of a library that holds the computer code parts, of a computer application that includes the executed computer code, for the executed computer code parts, etc., or any combination thereof.

Optionally, the derived behavioral profile, that was derived for the library that is determined to invoke the selected 120 system call, is used for analyzing 130 the selected 120 system call. For example, based on the derived behavioral profile it may be checked whether the selected 120 system call deviates from the derived behavior profile for the application that include the executed computer code.

In some exemplary embodiments, even if not all system call invocations by a computer code or a part thereof (say a library) are analyzed 130, given the random sampling and a large enough number of system call invocations, all computer code parts (say libraries) in use in the software development environment are likely to be identified.

Optionally, based on the identifying of libraries and/or other computer code parts, known vulnerabilities may be determined to be of potential relevance, e.g., using a Common Vulnerabilities and Exposures (CVE) database.

Accordingly, in one example, when analyzing 130 the selected 120 system call, which system call is initiated by the computer code when using the identified library, using the identified library's behavioral profile and/or the CVE database, it is determined 130 that the system call reflects a suspicious activity by the computer code.

Optionally, in the analyzing 130 of the selected 120 system call, the determined suspicious activity may be assessed with respect to potential exploitability of the determined vulnerabilities. In some exemplary embodiments, the assessment may be based, for example, on other libraries that are utilized by the same computer code during the execution (whether identified as utilized or having a behavioral profile that indicates utilization), based on hardware availability, based on previous detected activity, based on known attack vectors, or the like.

For example, a vulnerability related to a driver that may be exploited to use a fingerprint reader, may be found to be irrelevant if the computer on which the computer code execution takes place, does not include a fingerprint reader.

In some exemplary embodiments, different system calls may be treated differently, say based on being of a different system call type.

In some exemplary embodiments, some system call types may be considered to be more susceptible to malicious activity, and accordingly, all system calls of the types considered to be more susceptible to malicious activity may be selected 120 and analyzed 130, whereas only some of the system call other types are selected 120 and analyzed 130.

Thus, in one example, code execution system calls and network access system calls are considered to be of higher risk, and all their invocations are analyzed 130.

Further in the example, other system calls, e.g., memory access system calls, file access system calls, or the like, are considered to be of lower risk and are selected 120 (i.e. sampled) according to a general sampling rate that applies to all other system calls (i.e. to all system calls that are not of code execution or network access), or rather according to system call type specific sampling rates.

Thus, in the example, different levels of sampling may be employed.

For example, the system calls may be divided into groups, e.g., Group 1, Group 2, . . . , Group N, and each one of the groups may be assigned a respective, different sampling rate, such that the higher is the risk of the system calls of a specific one of the groups, the higher is the sampling rate assigned to that group.

Thus, for example, Group 1 may be considered of low risk, and be assigned with a low sampling rate, say 1%. Group 2 may be considered with higher risk than Group 1 but with lower risk compared to the other groups (e.g., Group i, where 2<i≤N), and be assigned a higher sampling rate (e.g., 5%>1%), etc.

Similarly, in the example, each Group i may be considered to be of a higher risk than its preceding group and lower risk than its succeeding group (e.g., Risk (Group i)<Risk (Group j)<Risk (Group k), where i<j<k), and accordingly their respective sampling rates may be set to be higher than the preceding group's sampling rate, and lower than the succeeding group's sampling rate (e.g., Sample Rate (Group i) <Sample Rate (Group j)<Sample Rate (Group k), where i<j<k).

In some exemplary embodiments, the sampling rate of the group with the highest risk may be 100%, thus ensuring that all system calls of the group of highest risk are always selected 120 and analyzed 130.

Optionally, once the analysis 130 of one of the selected 120 system calls identifies a potentially malicious activity, say a deviation from a behavioral profile of the library that invokes the analyzed 130 system call, all sampling rates are set to 100%. Accordingly, all system calls detected 110 after the setting of the sampling rates to 100% are selected 120 for analysis 130.

Optionally, the setting of the sampling rates set to 100% is limited to a predefined period of time, say until a predefined condition is met, or for a fixed, predefined period of time, say for 24 hours.

Potentially, the resultant monitoring of system calls may better enable a gathering of data that may be useful for system forensics, context and damage assessment, as known in the art.

Based on the analysis of the selected system call, a responsive action may be performed 140. The responsive action 140 may be aimed at mitigating the potential malicious activity, blocking invocation of the system call, increasing sampling rate of future system call invocations, notifying an administrator or creating a log for future reference, or the like.

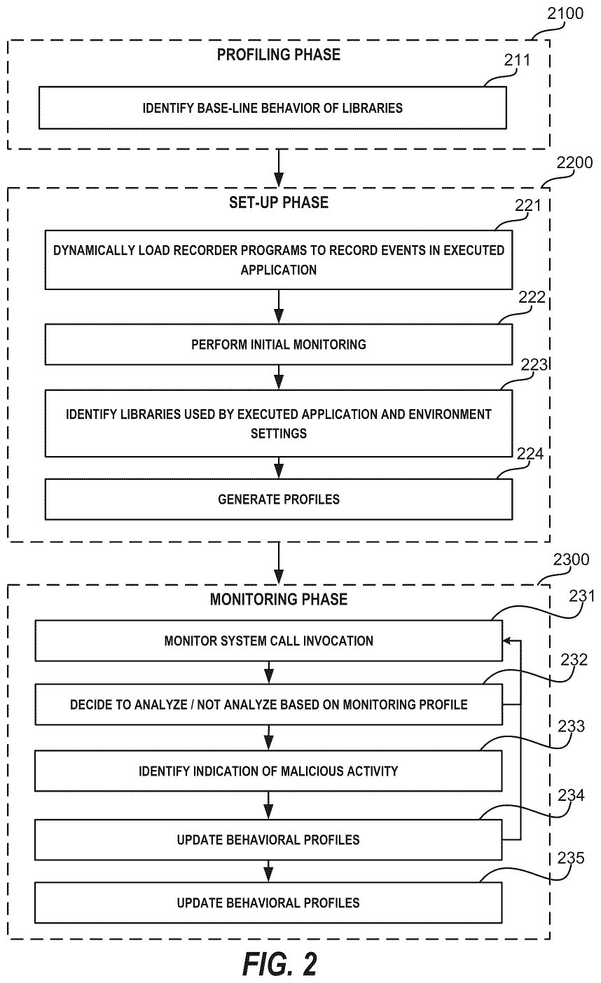

Reference is now made to FIG. 2, which is a simplified flowchart illustrating an exemplary scenario of dynamic runtime computer code monitoring, according to an exemplary embodiment of the disclosed subject matter.

An exemplary scenario of embodiment of dynamic runtime computer code monitoring, according to an exemplary embodiment of the disclosed subject matter, is based on an implementation of the exemplary method described in further detail and illustrated using FIG. 1 hereinabove.

The exemplary scenario includes phases of Profiling 2100, Set-Up 2200, and Monitoring 2300.

In the profiling phase 2100, a baseline behavior of the computer code and/or parts is identified 211.

Optionally, the profiling phase 2100 is performed offline, without accessing the executed computer code, or even before the computer code is developed (say by allowing a user to define the behavioral profile(s) for different functions and/or libraries, using a dedicated GUI (Graphical User Interface).

Initial behavior profiles of libraries are thus defined 211, so as to identifying a base-line accepted behavior that is a normal behavior expected for the library and/or functions.

In one example, at least one of the behavioral profiles includes a list of system calls that the library usually invokes and that is therefore allowed to use, a list of system calls that the library is not supposed to use, a dependency between the system calls invoked by the library (say an order that the system calls are supposed to be invoked in), devices or other system resources that the function usually accesses and is therefore allowed to access, etc.

The scenario's set-up phase 2200 is carried out during execution of the computer code.

Initially, recorder programs, such as a system call recorder, a function recorder, and/or the like, may be dynamically loaded 221 to the application.

In one example, the recorder program(s) may be integrated using hooks to be invoked when a function is invoked, when a function is exited, when a system call is invoked, etc.

Then, initial monitoring 222 may be performed, say for a predefined time period, to identify the environment in which the computer code is executed, say to identify 223 libraries and/or computer code parts (say functions) that are utilized by the computer code and/or that take a part in operation of an application that computer code is included in, etc.

The initial monitoring 222 may involve a sampling (say selecting 120) of detected 110 system calls at an initial, relatively low sampling rate and an analysis 130 of the sampled (i.e. selected 120) system call calls.

Then, based on the initial monitoring 222 and the identifying 223, a behavioral profile is generated 224 for the library that stores the computer code part, for the application that the computer code is a part of, etc., or any combination thereof.

Optionally, a behavioral profile may also be affected by environment settings, such as available hardware, drivers, resources, or the like.

During the exemplary scenario's protection phase 2300, as the computer code's execution continues, the computer code is monitored 231, for detecting 110 system calls invocation by the computer code.

For each detected 110 system call, there is decided 232 whether the detected 110 system call is to be analyzed 130, thus selecting 120 the system call.

In the exemplary scenario, in the method's step of analysis 130, there may be identified 233 an indication of a potentially malicious activity of the system call.

Optionally, a corrective or mitigative step is then carried out, say by stopping the system call and thus preventing the operating system from carrying out the service responsive to the system call.

Optionally, in the exemplary scenario, the sampling rate of system calls of a same type as of the analyzed 130 system call is updated 234 based on the identified 233 potentially malicious activity, thus dynamically updating the monitoring pattern applied using the exemplary method.

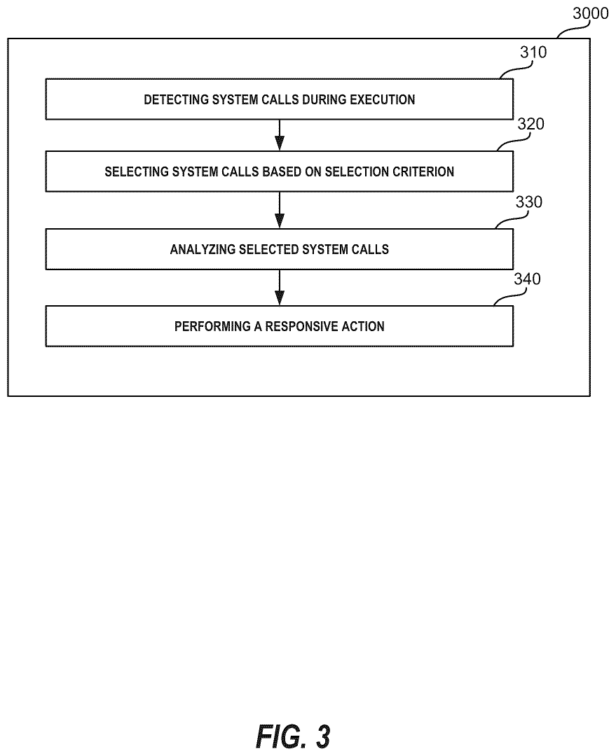

Reference is now made to FIG. 3, which is a simplified block diagram schematically illustrating a third exemplary non-transitory computer readable medium having stored thereon instructions for causing a processing circuitry to perform a process of dynamic runtime computer code monitoring, according to an exemplary embodiment of the disclosed subject matter.

According to an exemplary embodiment of the disclosed subject matter, there is provided a non-transitory computer readable medium 3000.

The medium 3000 may include, but is not limited to, a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

Optionally, the computer readable medium 3000 is a part of a system used to implement the exemplary method illustrated in FIG. 1.

Optionally, the instructions are computer-executable instructions coded and stored on the medium 3000 by a programmer. The instructions may be executed on one or more computers (say by one or more processors of the computer that system is implemented on).

The instructions include a step of detecting 310, during execution of a computer code, one or more system calls that are invoked during the execution of the computer code.

Optionally, each system call is detected 310 upon initiation of the system call by the computer code (say by a function used by the computer code), during the execution of the computer code, but before the service that is responsive to the system call is provided by the operating system of the computer.

For example, the system call may be detected 310 using tools for tracing the initiation of system calls in runtime, say by reading one or more memory areas in use by the operating system, using the Linux ‘strace’ utility, etc.

During the execution of the computer code, there is selected 320 one or more of the detected 310 system calls, based on a selection criterion, say a criterion predefined by a user or operator of the system.

Optionally, the selection 320 of the detected 310 system calls is carried out during the execution of the computer code, by determining for a detected 310 system call, before execution of an operating system service responsive to the detected 310 system call, whether the specific detected 310 system call should be analyzed 130.

Optionally, the selection criterion is based at least partially, on system call type, say on a sampling rate defined for each respective one of a plurality of system call type in a preliminary step of the exemplary method, and in advance of the detection 310 of the system calls.

In one example, the criterion defines that all detected 310 system calls of a first type are selected 320 and thus forwarded to the step of analyzing 330, whereas detected 310 system calls of a second type are sampled according to a respective, call type-specific sampling rate.

In the example, the system calls of the second type are sampled by selecting 320 the calls randomly, such that some (but not all) of the system calls of the second type are selected 320 for analysis 330.

Optionally, the criterion is based, at least partially, on a sampling rate predefined for each respective one of a plurality of system call types, and updated dynamically.

Thus, in one example, a user (say operator or programmer) defines a selection criterion, according to which criterion, initially (i.e. upon the starting of the execution of the computer code), all detected 310 Linux ‘fork’ system calls are selected 320 for analysis 330. The user-defined criterion further defines that only 5% of the ‘write’ system calls, but none of the ‘mkdir’ system calls, are analyzed 330.

In the example, upon detecting a suspicious activity by one of the detected 310 system calls selected 320 and analyzed 330, the originally user-defined criterion is updated automatically, say so as to define that 50% of detected 310 ‘write” system calls too are selected 320 for analysis 330, and that 10% of the ‘mkdir’ system calls are selected 320 for the analysis 330.

The selected 320 system call is analyzed 330 according to one or more rules.

The one or more rules are defined in advance of the analyzing 330, say by a user (say a programmer or operator) of a system that implements the exemplary method.

Optionally, the predefined rule used in the analysis 330 relates to a previously learnt behavioral profile of a part of the computer code (say a function used by the computer code during execution of the computer code).

Optionally, the learnt behavioral profile of the computer code part dictates that the analysis 330 include checking whether an action carried out using the selected 320 system call deviates from the learnt behavioral profile and hence, from the predefined rule.

Thus, in a first example, a behavioral profile of a part of the computer code (say a specific function, etc., as known in the art) learnt over one or more previous uses of the part by a computer code, during execution of the computer code, indicates that the computer code never requests access to system administration tables.

Accordingly, in the first example, the rule defines that the computer code part is not supposed to access a system administration table.

When the computer code, while using the computer code part (say function) requests the access, using the system call selected 320 and analyzed 330, the analysis 330 of the system call indicates the occurrence of an action (namely, the request to access the table) that deviates from the previously learnt behavioral profile.

Optionally, the rule rather relates to a previously learnt behavioral profile of a library that the computer code part originates from.

Optionally, the library behavioral profile represents an aggregation of two or more computer code part (say function) specific behavioral profiles. Each one of the computer code part specific profiles are learnt for a respective computer code part (say function) stored in the library, during multiple uses of the computer code part during computer execution.

Accordingly, the analyzing 330 comprises checking whether an action carried out using the selected 320 system call deviates from the predefined rule that is based on the behavioral profile of the library (say the aggregated behavioral profile).

Optionally, the rule rather relates to a previously learnt behavioral profile of a computer application that the computer code is a part of, and the analyzing 330 comprises checking whether an action carried out using the selected 320 system call deviates from the predefined rule.

In some exemplary embodiments, based on the analysis, a responsive action 340 may be performed. The responsive action may be to increase sampling rate for other system calls, to block the execution of the system call, to prevent the system from performing a specific action, to notify an administrator, to log information for future review, or the like.

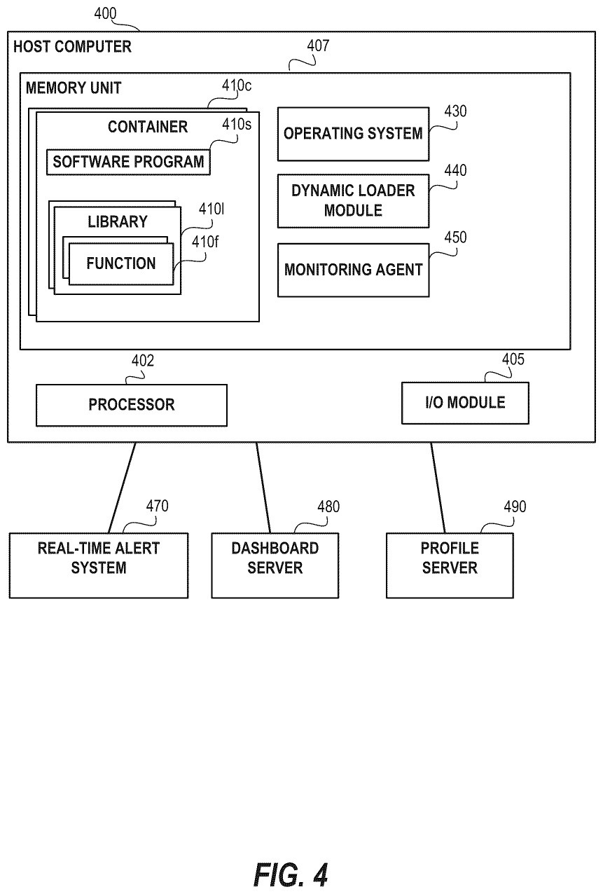

Reference is now made to FIG. 4, which shows a block diagram of a system, in accordance with some exemplary embodiments of the disclosed subject matter.

Host Computer 400 may be a node of a container orchestration system, capable of dynamically deploying containers, such as 410c, that are used to execute programs.

In some exemplary embodiments, Host Computer 400 may comprise a Processor 402. Processor 402 may be a Central Processing Unit (CPU), a microprocessor, an electronic circuit, an Integrated Circuit (IC), or the like. Processor 402 may be utilized to perform computations required by Host Computer 400 or any of its subcomponents. Processor 402 may be configured to execute computer programs useful in performing the methods of FIGS. 1, 2, or the like.

In some exemplary embodiments of the disclosed subject matter, an Input/Output (I/O) Module 405 may be utilized to provide an output to and receive input from a user such as via user interactions. I/O Module 405 may be used to transmit and receive information to and from the user or any other apparatus.

In some exemplary embodiments, Host Computer 400 may comprise a Memory Unit 407. Memory Unit 407 may be a short-term storage device or a long-term storage device. Memory Unit 407 may be a persistent storage or volatile storage. Memory Unit 407 may be a disk drive, a Flash disk, a Random Access Memory (RAM), a memory chip, or the like. In some exemplary embodiments, Memory Unit 407 may retain program code operative to cause Processor 402 to perform acts associated with any of the subcomponents of Host Computer 400.

In some exemplary embodiments, Host Computer 400 may have an Operating System 430. Operating System 430 may be configured to provide access to OS resources, such as but not limited to network connectivity (e.g., via I/O Module 405), access to the file system (e.g., via Memory Unit 407), invoke execution of a new code, or the like. Operating System 430 may utilize two different modes for managing processes: kernel mode and user mode. Kernel mode is a privileged mode that allows the software to access system resources, such as those made available via Memory Unit 407 and I/O Module 405, and perform privileged operations. User mode, on the other hand, is a restricted mode that limits the software's access to system resources. Processor 402 may be configured to switch between these two modes depending on the type of code that is being executed. Applications typically run in user mode, while core operating system components run in kernel mode. When a user-level application needs to perform an operation that requires kernel mode access, it must make a system call to the operating system kernel. The operating system then switches Processor 402 from user mode to kernel mode to execute the system call and switches back to user mode once the operation is complete.

Memory Unit 407 may retain one or more containers (410c). Each Container 410c includes a Software Program 410s and one or more Libraries 4101. Containers provide an isolated environment for running applications and their dependencies, allowing for efficient resource utilization and scalability. By packaging the Software Program 410s and its required Libraries 4101 within a Container 410c, the application can be easily deployed and managed within the container orchestration system. Each Library 4101 may be composed of multiple Functions (410f). In some cases, there may be hundreds, thousands, or more Functions 410f that are implemented by a Library 4101.

Dynamic Loader Module 440 may be configured to dynamically attach monitoring functions, such as functions that record entry points to functions, exit points from functions and system call invocations. In some cases, Dynamic Loader Module 440 may attach eBPF functions. In other cases, other technologies may be utilized to dynamically deploy and attach on-the-fly code that enables information to be passed to a separate processing space.

Monitoring Agent 450 may be configured to receive information monitored by the monitoring functions. In some cases, Monitoring Agent 450 may be deployed using a container. In some cases, a single Monitoring Agent 450 process/container may be utilized to monitor information received regarding a plurality of deployed containers (410c).

In some cases, Monitoring Agent 450 may obtain a behavioral profile of authorized functionalities. The behavioral profile may be associated with a specific Library 4101, with a specific Function 410f, or the like. In some cases, the behavioral profile may be a general behavioral profile for all instances of the Library 4101, Function 410f, or the like. In other cases, the behavioral profile may be container-specific and relate specifically to Library 4101, Function 410f, or the like of the specific associated Container 410c. The behavioral profile may be retrieved from a server, such as Profile Server 490. Profile Server 490 may prepare in advance pre-defined behavioral profiles, such as based on analysis of the relevant library, function, container, or the like. In some cases, Profile Server 490 may determine the behavioral profile based on static analysis of the relevant code. Additionally, or alternatively, Profile Server 490 may determine the behavioral profile based on dynamic analysis, such as based on benign execution of the relevant code.

In some exemplary embodiments, Monitoring Agent 450 may identify deviations from the previously learnt behavioral profile. Monitoring Agent 450 may build a stack trace to identify which one or more libraries/functions are responsible for each system call invocation. A policy related to the relevant library/function(s) may be obtained and consulted to determine if the system call invocation is in line with the relevant one or more previously learnt behavioral profile. Monitoring Agent 450 may perform responsive action(s) in response to deviations from one or more previously learnt behavioral profiles. For example, Monitoring Agent 450 may identify that the invocation of system calls deviates from the previously learnt behavioral profile and prevent invocation thereof. As another example, Monitoring Agent 450 may alert a user, such as using Real-Time Alert System 470, of the deviation. As yet another example, relevant information may be logged, enabling Dashboard Server 480 to present visual information to a user, showing which libraries/functions exhibit deviations from their respective previously learnt behavioral profiles. In some cases, Dashboard Server 480 may be utilized to present the previously learnt behavioral profile of libraries/functions. A user may select a library/function and view the respective previously learnt behavioral profile thereof.

Monitoring Agent 450 may be configured to obtain the selection criterion and apply such criterion when monitoring system call invocations. Additionally, or alternatively, Monitoring Agent 450 may be configured to obtain the previously learnt behavioral profile from Profile Server 490 and detect deviation therefrom. Monitoring Agent 450 may be configured to determine which responsive action should be performed with respect to the deviation and implement such responsive action.

It is expected that during the life of this patent many relevant devices and systems will be developed and the scope of the terms herein, particularly of the terms “Computer”, “Code”, “Library”, “Function”, “System Call”, “Micro SD Card”, “CD-ROM”, “USB-Memory”, “Hard Disk Drive (HDD)”, “Solid State Drive (SSD)”, “ROM chip”, “SRAM (Static Random Access Memory)”, “DRAM (Dynamic Random Access Memory)”, “RAM (Random Access Memory)”, “Cache Memory” and “Processor”, is intended to include all such new technologies a priori.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, the present embodiments may be combined with used a system that performs dynamic runtime micro-segmentation, as disclosed, for example, in U.S. patent application Ser. No. 18/203,476, titled “DYNAMIC RUNTIME MICRO-SEGMENTATION OF INTERPRETED LANGUAGES”, filed May 30, 2023, which is hereby incorporated by reference in its entirety for all purposes without giving rise to disavowment. However, the disclosed subject matter may be applied on other systems as well.

Thus, in some exemplary embodiments, dynamic runtime micro-segmentation of applications into modules, libraries, one or more methods, one or more functions, or any other computer codes or portion thereof, referred to, for simplicity, as “libraries”.

The role of each library inside the application is more structured and defined, compared to the application, allowing the creation of a deterministic and tight profile of activity for each library. For example, as opposed to the problem of an application requiring different permissions to perform its functionality, e.g., access permission to the filesystem, the network, to process execution, or the like, each library may require much limited permissions. As an example, a parser library will generally only need access to the filesystem, a camera library will require access to I/O module of certain type but have no need to access the network, and a network module may require network permissions but may not need to access the filesystem or other I/O modules.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the disclosed subject matter.

Unless otherwise defined, all technical and scientific terms used herein have the same meaning as commonly understood by one of ordinary skill in the art to which this disclosed subject matter belongs. The materials, methods, and examples provided herein are illustrative only and not intended to be limiting.

Implementation of the method and system of the disclosed subject matter involves performing or completing certain selected tasks or steps manually, automatically, or a combination thereof. Moreover, according to actual instrumentation and equipment of preferred embodiments of the method and system of the disclosed subject matter, several selected steps could be implemented by hardware or by software on any operating system of any firmware or a combination thereof.

For example, as hardware, selected steps of the disclosed subject matter could be implemented as a chip or a circuit. As software, selected steps of the disclosed subject matter could be implemented as a plurality of software instructions being executed by a computer using any suitable operating system. In any case, selected steps of the method and system of the disclosed subject matter could be described as being performed by a data processor, such as a computing platform for executing a plurality of instructions.

The disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method for dynamic runtime computer code monitoring, the method is performed by a computer processor, the method comprising:
during execution of a computer code, detecting a plurality of system calls initiated during the execution;
during the execution of the computer code, selecting at least one of the detected system calls, wherein the selection of the at least one of the detected system calls is performed based on a selection criterion; and
analyzing the selected system call, according to at least one predefined rule.

2. The method of claim 1, wherein the selected system calls are fewer than the detected system calls.

3. The method of claim 1, wherein the selection criterion is based at least on system call type.

4. The method of claim 1, wherein according to the selection criterion, all system calls of a first type are selected and subjected to said analyzing, but only some of a plurality of system calls of a second type are selected and subjected to said analyzing.

5. The method of claim 1, wherein said selecting is carried out during the execution of the computer code, by determining for each respective one of the detected system calls, before execution of an operating system service responsive to the respective system call, whether the respective system call should be analyzed.

6. The method of claim 1, wherein the predefined criterion is based at least partially on a sampling rate predefined for each respective one of a plurality of system call types.

7. The method of claim 1, wherein the selection criterion is based at least partially on a sampling rate predefined for each respective one of a plurality of system call types, and updated dynamically.

8. The method of claim 1, wherein the selection criterion defines a preliminary sampling rate of the detected system calls.

9. The method of claim 1, wherein the selection criterion defines a preliminary call-type-specific sampling rate for each respective one of a plurality of system call types.

10. The method of claim 9 further comprising updating the call-type-specific sampling rate according to a result of said analyzing.

11. The method of claim 1, wherein the predefined rule relates to a previously learnt behavioral profile of at least a part of the computer code, and said analyzing comprises checking whether an action carried out using the selected system call deviates from the predefined rule.

12. The method of claim 11, wherein the part of the computer code is included in a computer application, the computer application is different than the computer code, wherein the previously learnt behavior profile is determined based on executions of the computer application, whereby the behavior profile utilized during execution of the computer code is based on executions of a different computer program.

13. The method of claim 1, wherein the predefined rule relates to a previously learnt behavioral profile of a library, the library includes a plurality of functions, wherein the previously learnt behavioral profile of the library is based on behavior of the plurality of functions, wherein the part of the computer code is one of the plurality of functions, and said analyzing comprises checking whether an action carried out using the selected system call deviates from the predefined rule.

14. A non-transitory computer readable medium storing computer processor executable instructions for dynamic runtime computer code monitoring, the method comprising steps a computer processor is programmed to perform, the steps comprising:
during execution of a computer code, detecting a plurality of system calls initiated during the execution;
during the execution of the computer code, selecting a least one of the detected system calls, based on a selected criterion; and
analyzing the selected system call, according to at least one predefined rule.

15. The non-transitory computer readable medium of claim 14, wherein the criterion is based at least on system call type.

16. The non-transitory computer readable medium of claim 14, wherein according to the criterion, all system calls of a first type are selected and subjected to said analyzing, but only some of a plurality of system calls of a second type are selected and subjected to said analyzing.

17. The non-transitory computer readable medium of claim 14, wherein said selecting is carried out during the execution of the computer code, by determining for each respective one of the detected system calls, before execution of an operating system service responsive to the respective system call, whether the respective system call should be analyzed.

18. The non-transitory computer readable medium of claim 14, wherein the selected criterion is based at least partially on a sampling rate predefined for each respective one of a plurality of system call types.

19. The non-transitory computer readable medium of claim 14, wherein the selection criterion is based at least partially on a sampling rate predefined for each respective one of a plurality of system call types, and updated dynamically.

20. A system for of dynamic runtime computer code monitoring, the system comprising a circuit comprising a computer processor and a computer memory storing instructions that are executable by the computer processor, for performing the steps of:
during execution of a computer code, detecting a plurality of system calls initiated during the execution;
during the execution of the computer code, selecting a least one of the detected system calls, based on a selection criterion; and
analyzing the selected system call, according to at least one predefined rule.
